(19) United States
(12) Patent Application Publication
(10) Pub. No.: US 2019/0335762 A1
(43) Pub. Date: Nov. 7, 2019

(54) NON-TOXIC INSECTICIDE COMPOSITION

(71) Applicant: John R Smith, Tobyhanna, PA (US)

(72) Inventor: John R Smith, Tobyhanna, PA (US)

(21) Appl. No.: 16/511,754

(22) Filed: Jul. 15, 2019

(51) Int. Cl. A01N 65/44; A01N 65/22

(52) U.S. Cl. CPC A01N 65/44; A01N 65/22

(57) ABSTRACT

The embodiments herein disclose a herbal oil based non-toxic insecticide composition comprises lemon grass oil, peppermint oil and liquid soap/soap solution. The herbal oil based non-toxic insecticide composition is tested on the insects/bugs. The predetermined amount of lemon grass oil is in a range of 3% v/v-45% v/v. The predetermined amount of peppermint oil is in a range of 0.05% v/v-25% v/v. The predetermined amount of liquid soap/soap solution is in a range of 0.01% v/v-20% v/v. The liquid soap/soap solution does not comprise chemical dyes, perfumes and phosphate composition. The soap solution/liquid soap is plant based and does not comprise animal derived products. The soap solution/liquid soap prevents separation of peppermint oil and lemon grass oil in the herbal oil based non-toxic insecticide composition. The bed bugs, roaches and hornets die after spraying the herbal oil based non-toxic insecticide composition.

### CROSS-REFERENCE TO RELATED APPLICATIONS

This application claims the priority of U.S. Provisional Patent Application No. 527663038, filed on Nov. 28, 2018, with the tile, “NONTOXIC INSECTICIDE”, and the content of which is incorporated in its entirety by reference herein.

### BACKGROUND

### Technical Field

The embodiments herein are generally related to a field of natural insecticide composition. The embodiments herein are particularly related to a safe, green, natural eco-friendly insecticide and method of synthesizing the same. The embodiments herein are more particularly related to an insecticide composition which destroys insects, parasites or organisms which harm animals, plants and human beings.

### Description of the Related Art

Insecticides are substances which are used to kill insects. Insecticide comprises ovicides and larvicides which are used against insect eggs and larvae respectively. Insecticides are claimed to be a major factor behind the increase in the 20^{th} century's agricultural productivity. Nearly all insecticides have the potential to significantly alter ecosystems; many are toxic to humans and/or animals; some become concentrated as they spread along the food chain.

Insecticides are chemical substances that deter, incapacitate, kill or otherwise discourage any pests from coming in contact with an object, a person, or an animal. The target pests comprises insects such as mosquitoes, flies, ticks, carpenter bees, ants, roaches, flies, bed bugs, wasps, silver fish, lady beetles or the organisms harmful to animals and humans. Insects can cause nuisance, spread disease or are disease vectors.

Insecticides include ovicides and larvicides used against insects, eggs and larvae respectively. Insecticides find their application in agriculture, medicine, industry and by the consumers. Although insecticides have a plurality of benefits, insecticides use raises a number of environmental concerns. For instance, all insecticides have the potential to significantly alter ecosystems. Insecticide may reach water, air and soil causing pollution and contamination.

Some insecticides are toxic to humans and animals. Insecticides may cause acute and delayed health effects to those who are exposed. Exposure to insecticides is known to cause variety of adverse health effects, ranging from simple irritation of the skin and eyes to more sever effects such as negatively impacting the nervous system, damaging reproductive organs and causing cancer. Thus, it becomes necessary to use natural insecticides, organic insecticides or plant based insecticides that are safe for application.

The toxic insecticides available in the market these days kill the bugs/insects in 2 minutes. But they cause harmful effects to human beings and animals. Further the non toxic sprays comprise pyrethroids which are synthesized chemically.

Hence there is a need for an herbal oil spray which is non toxic to environment. Also, there is a need for an eco-friendly and non-toxic insecticide. Further there is a need for non-toxic herbal oil based insecticidal spray which does not comprise harmful preservative.

The above-mentioned shortcomings, disadvantages and problems are addressed herein and which will be understood by reading and studying the following specification.

### OBJECTIVES OF THE EMBODIMENTS

The primary objective of the embodiment herein is to provide an herbal oil spray which is non toxic to environment.

Another object of the embodiment herein is to provide an eco-friendly and non-toxic insecticide.

Yet another object of the embodiment herein is to provide non-toxic herbal oil based insecticidal spray which does not comprise harmful preservative.

Yet another object of the embodiment herein is to provide non-toxic herbal oil based insecticidal spray which is non-carcinogenic and does not harm human beings and wildlife.

Yet another object of the embodiment herein is to provide non-toxic herbal oil based insecticidal spray which is synthesized from lemon grass oil, peppermint oil and soap.

Yet another object of the embodiment herein is to provide non-toxic herbal oil based insecticidal spray which is cheap and easily synthesized.

These objects and the other advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The embodiments herein provide an herbal oil spray which is non toxic to environment. The embodiments herein further provide an eco-friendly and non-toxic insecticide. The embodiments herein also provide non-toxic herbal oil based insecticidal spray which does not comprise harmful preservative.

According to one embodiment herein, the herbal oil based non-toxic insecticide composition comprises a predetermined amount of lemon grass oil, a predetermined amount of peppermint oil and a predetermined amount of liquid soap/soap solution. The herbal oil based non-toxic insecticide composition is tested on the insects/bugs.

According to one embodiment herein, the predetermined amount of lemon grass oil present in the herbal oil based non-toxic insecticide composition is in a range of 3% v/v-45% v/v. According to one embodiment herein, the minimum amount of lemon grass oil present in the herbal oil based non-toxic insecticide composition is 1% v/v. The maximum amount of the lemon grass oil present in the herbal oil based non-toxic insecticide composition is 90% v/v.

According to one embodiment herein, the predetermined amount of peppermint oil present in the herbal oil based non-toxic insecticide composition is in a range of 0.05% v/v-25% v/v. According to one embodiment herein, the minimum amount of peppermint oil present in the herbal oil based non-toxic insecticide composition is 0.05% v/v. The maximum amount of the peppermint oil present in the herbal oil based non-toxic insecticide composition is 60% v/v.

According to one embodiment herein, the predetermined amount of liquid soap/soap solution present in the herbal oil based non-toxic insecticide composition is in a range of 0.01% v/v-20% v/v. The liquid soap/soap solution does not comprise chemical dyes, perfumes and phosphate composition. The soap solution/liquid soap is plant derived. The soap solution/liquid soap does not comprise animal derived components. The soap solution/liquid soap is an inert ingredient in the herbal oil based non-toxic insecticide composition. The soap solution/liquid soap prevents separation of peppermint oil and lemon grass oil in the herbal oil based non-toxic insecticide composition.

According to one embodiment herein, the herbal oil based non-toxic insecticide composition is tested on the insects/bugs. The herbal oil based non-toxic insecticide composition is sprayed on the bed bugs, roaches and hornets. The bed bugs, roaches and hornets die after spraying the herbal oil based non-toxic insecticide composition.

According to one embodiment herein, the method of synthesizing herbal oil based non-toxic insecticide composition, comprises the following steps. 30 ml of lemon grass botanical oil is added in a bottle. 10 ml of peppermint oil is added in the bottle comprising lemon grass oil. 30.6 ounces (887.4 ml) of water is added to the bottle comprising lemon grass oil and peppermint oil. 0.4 ml of soap solution/liquid soap is added to the bottle comprising lemon grass oil, peppermint oil and water to obtain a mixture of non toxic insecticide composition. The bottle comprising the mixture is shaken so that all the ingredients of non toxic insecticide composition are uniformly mixed. The bottle is covered with cap and set aside. The mixture is herbal oil based non-toxic insecticide composition.

According to one embodiment herein, the predetermined amount of lemon grass oil present in the herbal oil based non-toxic insecticide composition is in a range of 3% v/v-45% v/v. According to one embodiment herein, the minimum amount of lemon grass oil present in the herbal oil based non-toxic insecticide composition is 1% v/v. The maximum amount of the lemon grass oil present in the herbal oil based non-toxic insecticide composition is 90% v/v.

According to one embodiment herein, the predetermined amount of peppermint oil present in the herbal oil based non-toxic insecticide composition is in a range of 0.05% v/v-25% v/v. According to one embodiment herein, the minimum amount of peppermint oil present in the herbal oil based non-toxic insecticide composition is 0.05% v/v. The maximum amount of the peppermint oil present in the herbal oil based non-toxic insecticide composition is 60% v/v.

According to one embodiment herein, the predetermined amount of liquid soap/soap solution present in the herbal oil based non-toxic insecticide composition is in a range of 0.01% v/v-20% v/v. The liquid soap/soap solution does not comprise chemical dyes, perfumes and phosphate composition. The soap solution/liquid soap is plant derived. The soap solution/liquid soap does not comprise animal derived components. The soap solution/liquid soap is an inert ingredient in the herbal oil based non-toxic insecticide composition. The soap solution/liquid soap prevents separation of peppermint oil and lemon grass oil in the herbal oil based non-toxic insecticide composition.

According to one embodiment herein, the herbal oil based non-toxic insecticide composition is tested on the insects/bugs. The herbal oil based non-toxic insecticide composition is sprayed on the bed bugs, roaches and hornets. The bed bugs, roaches and hornets die after spraying the herbal oil based non-toxic insecticide composition.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a flow chart illustrating the method of synthesizing herbal oil based non-toxic insecticide composition, according to one embodiment of the present invention.

Although the specific features of the present invention are shown in some drawings and not in others. This is done for convenience only as each feature may be combined with any or all the other features in accordance with the present invention.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide an herbal oil spray which is non toxic to environment. The embodiments herein further provide an eco-friendly and non-toxic insecticide. The embodiments herein also provide non-toxic herbal oil based insecticidal spray which does not comprise harmful preservative.

According to one embodiment herein, the herbal oil based non-toxic insecticide composition comprises a predetermined amount of lemon grass oil, a predetermined amount of peppermint oil and a predetermined amount of liquid soap/soap solution. The herbal oil based non-toxic insecticide composition is tested on the insects/bugs.

According to one embodiment herein, the predetermined amount of lemon grass oil present in the herbal oil based non-toxic insecticide composition is in a range of 3% v/v-45% v/v. According to one embodiment herein, the minimum amount of lemon grass oil present in the herbal oil based non-toxic insecticide composition is 1% v/v. The maximum amount of the lemon grass oil present in the herbal oil based non-toxic insecticide composition is 90% v/v.

According to one embodiment herein, the predetermined amount of peppermint oil present in the herbal oil based non-toxic insecticide composition is in a range of 0.05% v/v-25% v/v. According to one embodiment herein, the minimum amount of peppermint oil present in the herbal oil based non-toxic insecticide composition is 0.05% v/v. The maximum amount of the peppermint oil present in the herbal oil based non-toxic insecticide composition is 60% v/v.

According to one embodiment herein, the predetermined amount of liquid soap/soap solution present in the herbal oil based non-toxic insecticide composition is in a range of 0.01% v/v-20% v/v. The liquid soap/soap solution does not comprise chemical dyes, perfumes and phosphate composition. The soap solution/liquid soap is plant derived. The soap solution/liquid soap does not comprise animal derived components. The soap solution/liquid soap is an inert ingredient in the herbal oil based non-toxic insecticide composition. The soap solution/liquid soap prevents separation of peppermint oil and lemon grass oil in the herbal oil based non-toxic insecticide composition.

According to one embodiment herein, the herbal oil based non-toxic insecticide composition is tested on the insects/bugs. The herbal oil based non-toxic insecticide composition is sprayed on the bed bugs, roaches and hornets. The bed bugs, roaches and hornets die after spraying the herbal oil based non-toxic insecticide composition.

According to one embodiment herein, the method of synthesizing herbal oil based non-toxic insecticide composition, comprises the following steps. 30 ml of lemon grass botanical oil is added in a bottle. 10 ml of peppermint oil is added in the bottle comprising lemon grass oil. 30.6 ounces (887.4 ml) of water is added to the bottle comprising lemon grass oil and peppermint oil. 0.4 ml of soap solution/liquid soap is added to the bottle comprising lemon grass oil, peppermint oil and water to obtain a mixture of non toxic insecticide composition. The bottle comprising the mixture is shaken so that all the ingredients of non toxic insecticide composition are uniformly mixed. The bottle is covered with cap and set aside. The mixture is herbal oil based non-toxic insecticide composition.

According to one embodiment herein, the predetermined amount of lemon grass oil present in the herbal oil based non-toxic insecticide composition is in a range of 3% v/v-45% v/v. According to one embodiment herein, the minimum amount of lemon grass oil present in the herbal oil based non-toxic insecticide composition is 1% v/v. The maximum amount of the lemon grass oil present in the herbal oil based non-toxic insecticide composition is 90% v/v.

According to one embodiment herein, the predetermined amount of peppermint oil present in the herbal oil based non-toxic insecticide composition is in a range of 0.05% v/v-25% v/v. According to one embodiment herein, the minimum amount of peppermint oil present in the herbal oil based non-toxic insecticide composition is 0.05% v/v. The maximum amount of the peppermint oil present in the herbal oil based non-toxic insecticide composition is 60% v/v.

According to one embodiment herein, the predetermined amount of liquid soap/soap solution present in the herbal oil based non-toxic insecticide composition is in a range of 0.01% v/v-20% v/v. The liquid soap/soap solution does not comprise chemical dyes, perfumes and phosphate composition. The soap solution/liquid soap is plant derived. The soap solution/liquid soap does not comprise animal derived components. The soap solution/liquid soap is an inert ingredient in the herbal oil based non-toxic insecticide composition. The soap solution/liquid soap prevents separation of peppermint oil and lemon grass oil in the herbal oil based non-toxic insecticide composition.

According to one embodiment herein, the herbal oil based non-toxic insecticide composition is tested on the insects/bugs. The herbal oil based non-toxic insecticide composition is sprayed on the bed bugs, roaches and hornets. The bed bugs, roaches and hornets die after spraying the herbal oil based non-toxic insecticide composition.

According to one embodiment herein, an herbal oil based eco-friendly and non-toxic insecticide composition is provided. The herbal oil based non-toxic insecticide composition is sprayed on the target insects. The insecticide composition is safe for environment and living beings. The herbal oil based non-toxic insecticide composition kills the target insects. The herbal oil based non-toxic insecticide composition is synthesized without any preservatives. The herbal oil based non-toxic insecticide composition kills the insects/bugs physically and insects/bugs do not become immune. The herbal oil based non-toxic insecticide composition is good for long term use and is non-carcinogenic.

According to one embodiment herein, the herbal oil based non-toxic insecticide composition comprises lemon grass oil, peppermint oil and soap.

According to one embodiment herein, the lemon grass oil added in the herbal oil based non-toxic insecticide composition is in the form of a natural steam distilled botanical oil. The active ingredient in the lemon grass oil is terpenoid. The predetermined amount of lemon grass oil present in the herbal oil based non-toxic insecticide composition is in a range of 3% v/v-45% v/v. According to one embodiment herein, the minimum amount of lemon grass oil present in the herbal oil based non-toxic insecticide composition is 1% v/v. The maximum amount of the lemon grass oil present in the herbal oil based non-toxic insecticide composition is 90% v/v.

According to one embodiment herein, the peppermint oil added in the herbal oil based non-toxic insecticide composition is in the form of natural steam distilled botanical oil. The active ingredient is a monoterpene. The predetermined amount of peppermint oil present in the herbal oil based non-toxic insecticide composition is in a range of 0.05% v/v-25% v/v. According to one embodiment herein, the minimum amount of peppermint oil present in the herbal oil based non-toxic insecticide composition is 0.05% v/v. The maximum amount of the peppermint oil present in the herbal oil based non-toxic insecticide composition is 60% v/v.

According to one embodiment herein, the soap solution in the herbal oil based non-toxic insecticide composition is a dispersing agent for the oils. The soap solution is an inert ingredient for emulsifying oils. The predetermined amount of soap solution present in the herbal oil based non-toxic insecticide composition is in a range of 0.01% v/v-20% v/v.

According to one embodiment herein, the herbal oil based non-toxic insecticide composition kills the target insects after coming in contact with insect body. Majority of the bugs/insects have an exterior wax coating and the ingredients of herbal oil based non-toxic insecticide composition melt the wax coating of the insects in a short time period. The herbal oil based non-toxic insecticide composition also suffocates the pores of the insects or flying bugs.

According to one embodiment herein, individual components (peppermint oil, lemongrass oil and soap) are tested alone on plurality of bugs. It is observed that individual components (peppermint oil, lemongrass oil and soap) take more time to act on the insects.

According to one embodiment herein, a predetermined amount of individual components (peppermint oil, lemongrass oil and soap) are mixed to obtain the herbal oil based non-toxic insecticide composition. The herbal oil based non-toxic insecticide composition is in the form of a spray which kills the insects/bugs much more effectively and quickly without the use of toxic chemicals.

According to one embodiment herein, the herbal oil based non-toxic insecticide composition is used to kill target bugs such as carpenter bees, ants, roaches, flies, bed bugs, wasps, silver fish, lay beetles and the like. The herbal oil based non-toxic insecticide composition is sprayed on the target insects. The insects come in contact with the herbal oil based non-toxic insecticide composition and die eventually. The herbal oil based non-toxic insecticide composition is non-toxic and non-carcinogenic composition which do not harm humans and wildlife.

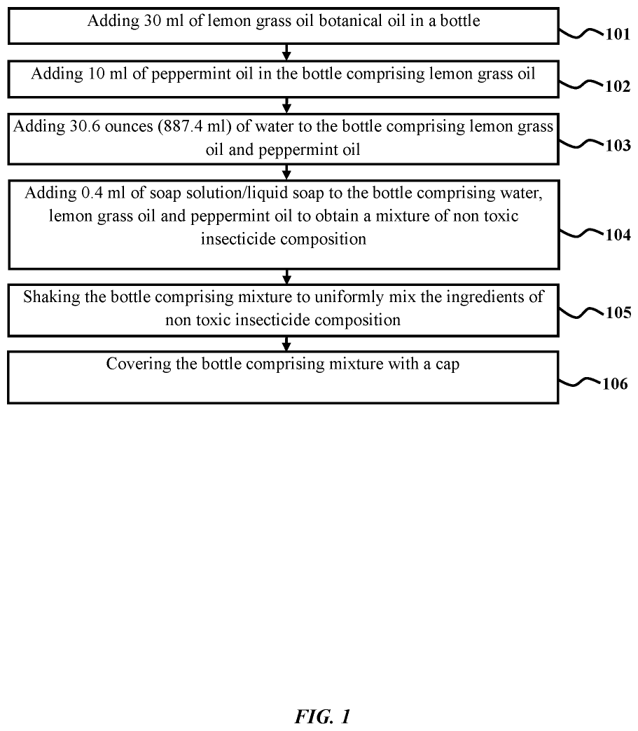

FIG. 1 is a flow chart illustrating the method of synthesizing herbal oil based non-toxic insecticide composition, according to one embodiment of the present invention.

According to one embodiment herein, herbal oil based non-toxic insecticide composition is synthesized by the following method. 30 ml of lemon grass botanical oil is added in a bottle (101). 10 ml of peppermint oil is added in the bottle comprising lemon grass oil (102). 30.6 ounces (887.4 ml) of water is added to the bottle comprising lemon grass oil and peppermint oil (103). 0.4 ml of soap solution/liquid soap is added to the bottle comprising lemon grass oil, peppermint oil and water to obtain a mixture of non toxic insecticide composition (104). The bottle comprising the mixture is shaken so that all the ingredients of non toxic insecticide composition are uniformly mixed (105). The bottle is covered with cap and set aside (106). The mixture is herbal oil based non-toxic insecticide composition.

According to one embodiment herein, the lemon grass oil is the botanical oil which is extracted in a steam distilled process. The steam distillation is a process that isolates the aromatic, volatile elements of the plant with steam. The lemon grass oil is added in the herbal oil based non-toxic insecticide composition in a range of 10% v/v.

According to one embodiment herein, the peppermint oil is a botanical oil extracted by steam distillation process. The steam distillation is a process that isolates the aromatic, volatile elements of the plant with steam. The peppermint oil is added in the herbal oil based non-toxic insecticide composition in a range of 2% v/v.

According to one embodiment herein, the only soap solution/liquid soap used is free from any dyes, perfumes and phosphates. The soap solution is a plant derived surfactant, vegan, gluten free and gray water septic safe. The soap solution/liquid soap is free from animal derived components. The soap solution/liquid soap is unscented dish soap used to dispense the mixture evenly in the herbal oil based non-toxic insecticide composition. Soap is considered as an inert ingredient. The liquid soap/soap solution prevents peppermint oil and lemongrass oil from separating in the solution. The range of liquid soap/soap solution is 0.01% v/v-20% v/v in the herbal oil based non-toxic insecticide composition. The exact amount of soap solution/liquid soap in the herbal oil based non-toxic insecticide composition is 0.4 ml.

According to one embodiment herein, the herbal oil based non-toxic insecticide composition is non-toxic when compared to the existing toxic insecticides which kill the insects in short time period.

According to one embodiment herein, the herbal oil based non-toxic insecticide composition is tested on bed bugs. It is observed that the bed bugs die within 5 seconds after spraying herbal oil based non-toxic insecticide composition. The herbal oil based non-toxic insecticide composition is tested on roaches. The roaches die within 10 seconds after spraying herbal oil based non-toxic insecticide composition. The herbal oil based non-toxic insecticide composition is tested on hornets. The hornets die soon after spraying herbal oil based non-toxic insecticide composition. The herbal oil based non-toxic insecticide composition interferes with the pheromone interceptors making it difficult for the insects and bugs to fly, target the invading intruder and sting.

It is to be understood that the phraseology or terminology employed herein is for description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A herbal oil based non-toxic insecticide composition, the composition comprises:
a predetermined amount of lemon grass oil;
a predetermined amount of peppermint oil; and
a predetermined amount of liquid soap/soap solution, and wherein the herbal oil based non-toxic insecticide composition is tested on the insects/bugs.

2. The composition according to claim 1, wherein the predetermined amount of lemon grass oil present in the herbal oil based non-toxic insecticide composition is in a range of 3% v/v-45% v/v.

3. The composition according to claim 1, wherein the predetermined amount of peppermint oil present in the herbal oil based non-toxic insecticide composition is in a range of 0.05% v/v-25% v/v.

4. The composition according to claim 1, wherein the predetermined amount of liquid soap/soap solution present in the herbal oil based non-toxic insecticide composition is in a range of 0.01% v/v-20% v/v, and wherein the liquid soap/soap solution does not comprise chemical dyes, perfumes and phosphate composition, and wherein the soap solution/liquid soap is plant derived, and wherein the soap solution/liquid soap does not comprise animal derived components, and wherein the soap solution/liquid soap is an inert ingredient in the herbal oil based non-toxic insecticide composition, and wherein the soap solution/liquid soap prevents separation of peppermint oil and lemon grass oil in the herbal oil based non-toxic insecticide composition.

5. The composition according to claim 1, wherein the herbal oil based non-toxic insecticide composition is tested on the insects/bugs, and wherein the herbal oil based non-toxic insecticide composition is sprayed on the bed bugs, roaches and hornets, and wherein the bed bugs, roaches and hornets die after spraying the herbal oil based non-toxic insecticide composition.

6. A method of synthesizing herbal oil based non-toxic insecticide composition, the method comprises:
adding 30 ml of lemon grass oil botanical oil in a bottle;
adding 10 ml of peppermint oil in the bottle comprising lemon grass oil;
adding 30.6 ounces (887.4 ml) of water to the bottle comprising lemon grass oil and peppermint oil;
adding 0.4 ml of soap solution/liquid soap to the bottle comprising water, lemon grass oil and peppermint oil to obtain a mixture of non toxic insecticide composition;
shaking the bottle comprising mixture to uniformly mix the ingredients of non toxic insecticide composition; and
covering the bottle comprising mixture with a cap.

7. The method according to claim 6, wherein the predetermined amount of lemon grass oil present in the herbal oil based non-toxic insecticide composition is in a range of 3% v/v-45% v/v.

8. The method according to claim 1, wherein the predetermined amount of peppermint oil present in the herbal oil based non-toxic insecticide composition is in a range of 0.05% v/v-25% v/v.

9. The method according to claim 1, wherein the predetermined amount of liquid soap/soap solution present in the herbal oil based non-toxic insecticide composition is in a range of 0.01% v/v-20% v/v, and wherein the liquid soap/soap solution does not comprise chemical dyes, perfumes and phosphate composition, and wherein the soap solution/liquid soap is plant derived, and wherein the soap solution/liquid soap does not comprise animal derived components, and wherein the soap solution/liquid soap is an inert ingredient in the herbal oil based non-toxic insecticide composition, and wherein the soap solution/liquid soap prevents separation of peppermint oil and lemon grass oil in the herbal oil based non-toxic insecticide composition.

10. The method according to claim 1, wherein the herbal oil based non-toxic insecticide composition is tested on the insects/bugs, and wherein the herbal oil based non-toxic insecticide composition is sprayed on the bed bugs, roaches and hornets, and wherein the bed bugs, roaches and hornets die after spraying the herbal oil based non-toxic insecticide composition.
